(19) United States
(12) Patent Application Publication
(10) Pub. No.: US 2022/0188489 A1
(43) Pub. Date: Jun. 16, 2022

(54) COMPUTER-IMPLEMENTED METHOD FOR MODIFYING A COMPONENT OF A COMPUTER-GENERATED MODEL OF A MOTOR VEHICLE

(71) Applicant: Dr. Ing. h.c. F. Porsche Aktiengesellschaft, Stuttgart (DE)

(72) Inventor: Matteo Skull, Stuttgart (DE)

(73) Assignee: Dr. Ing. h.c. F. Porsche Aktiengesellschaft, Stuttgart (DE)

(21) Appl. No.: 17/548,740

(22) Filed: Dec. 13, 2021

(30) Foreign Application Priority Data
Dec. 16, 2020 (DE) 10 2020 133 654.3

(51) Int. Cl. G06F 30/27; G06V 10/75

(52) U.S. Cl. CPC G06F 30/27; G06F 2113/00; G06V 10/75

(57) ABSTRACT

A method for modifying a component of a computer-generated model of a vehicle includes the steps of: performing a first simulation of a first accident of the model resulting in components of the model being deformed, producing a first video from the simulation, comparing frames of the first video with one another, calculating a first deformation sum from the comparison of the frames of the first video, modifying at least one of the components, performing a second simulation of a second accident of the model with the at least one modified component, producing a second video from the second simulation, comparing frames of the second video with one another, calculating a second deformation sum from the comparison of the frames of the second video, comparing the deformation sums, and rating the modification on the basis of the comparison of the deformation sums.

### CROSS-REFERENCE TO RELATED APPLICATION

This application claims priority to German Patent Application No. 10 2020 133 654.3, filed Dec. 16, 2020, the content of such application being incorporated by reference herein in its entirety.

### FIELD OF THE INVENTION

The present invention concerns a computer-implemented method for modifying a component of a computer-generated model of a motor vehicle. A computer-implemented method is understood within the context of this description to mean in particular that the method is carried out by a computer. The computer can comprise a digital data memory and a processor, for example. The digital data memory may store instructions that, when executed by the processor, prompt the processor to carry out the computer-implemented method.

### BACKGROUND OF THE INVENTION

Computer-generated models of a motor vehicle are used in the prior art to simulate the effect of an accident on different components of the motor vehicle, for example the bodywork. A video of the simulated accident is produced and is analyzed by a user with regard to deformations of the components.

WO 2008/052743 A1, which is incorporated herein by reference, discloses the practice of performing a simulation of a computer-generated model of a part with respect to a specific characteristic of the part and improving this characteristic by means of a computer-implemented method.

### SUMMARY OF THE INVENTION

By contrast, the present invention relates to evaluating a video produced from a computer-generated simulation of an accident without the need for interaction by a user.

The method described herein is used to modify a component of a computer-generated model of a motor vehicle. This can be a CAD model, for example. The computer-generated model may in particular have been produced by an interaction of a user with a computer. The term “computer-generated” is understood within the context of this description to mean in particular that the model is available only in the form of digital data and not in the form of real parts.

First, a first computer-generated simulation of a first accident of the computer-generated model is performed. The computer-generated model comprises multiple components, some of which are deformed during the first computer-generated simulation. A first video that visually represents the first simulated accident of the model is produced from the computer-generated simulation. Frames of the first video are compared with one another. It is in particular possible for just two frames to be compared with one another. These can be in particular a frame before the accident and a frame after the accident, if the components of the model are deformed. It is also possible for more than two frames to be compared with one another.

A first deformation sum is calculated from the comparison of the frames of the first video. The first deformation sum is calculated from deformations of the components during the first simulated accident. The first deformation sum can be calculated using deformations of all or just some of the components.

At least one of the components is then modified. It is also possible for multiple instances of the components to be modified. This modification can be made in particular fully automatically without interaction by a user. A second computer-generated simulation of a second accident of the model with the at least one modified component is subsequently performed. It is important to note that the components are not deformed before the second simulation is performed. The second simulation results in components of the model being deformed. A second video that visually represents the second simulated accident of the model is produced from the second simulation. Frames of the second video are compared with one another. It is in particular possible for just two frames to be compared with one another. These can be in particular a frame before the accident and a frame after the accident, if the components of the model are deformed. It is also possible for more than two frames to be compared with one another.

A second deformation sum is calculated from the comparison of the frames of the second video. The second deformation sum is calculated from deformations of the components during the second simulated accident. The second deformation sum is compared with the first deformation sum. This comparison is taken as a basis for rating the modification as positive or negative.

This allows the computer-generated model to be improved with respect to its accident characteristics. Since both the computer-generated model and the simulation of the accident are very realistic, it can be assumed that a positively rated modification also has a positive influence on the accident behavior of a real motor vehicle to which the computer-generated model corresponds.

The rating of the modifications as positive or negative can in particular be in the form of part of machine learning. A so-called agent makes the modifications in that case. If the modification is rated positively, this is a reward for the agent. The agent attempts to obtain as many rewards as possible, as a result of which it learns independently and the model is recurrently modified particularly well.

According to one embodiment of the invention, the model with the at least one modified component can be remodified if the modification was rated as positive. This is understood within the context of this description to mean in particular that one or more of the components are modified. By way of example, already modified components can be remodified or other components can be modified for the first time. On the other hand, the model with the at least one modified component can be rejected if the modification was rated as negative.

The remodification is followed by a third computer-generated simulation of a third accident of the remodified model being performed and a third video being produced from the third computer-generated simulation.

The third computer-generated simulation results in components of the model being deformed. The third video visually represents the third simulated accident of the remodified model. Frames of the third video are compared with one another. A third deformation sum is calculated from the comparison of the frames of the third video. The third deformation sum is calculated from deformations of the components during the third simulated accident. The remodification is rated as positive or negative on the basis of a comparison of the second deformation sum with the third deformation sum. In this way, the computer-generated model is optimized further with respect to its characteristics during a simulated accident.

According to one embodiment of the invention, the steps of the method can be repeated until a difference between a target deformation sum and one of the deformation sums is below a threshold value. The threshold value can be for example proportionally dependent on the target deformation sum. By way of example, the threshold value can differ from the target deformation sum by 5%.

In this embodiment, the computer-generated model is improved with respect to its characteristics during a simulated accident until the target deformation sum has been reached at least approximately. Since the method can be performed without interaction with a user, it is of minor importance how long it takes before the target deformation sum has been reached at least approximately.

According to one embodiment of the invention, the modified model can be rated as positive if the second deformation sum is less than the first deformation sum. The same applies to the remodified model if the third deformation sum is less than the second deformation sum.

According to one embodiment of the invention, the modification can be rated as positive or negative by a reward function. This can apply in particular to all ratings of all modifications. The reward function can be in self-learning form. Before rating the modification, the reward function can learn from user alterations to the computer-generated model and the performance of simulations of accidents using the user-altered models. User alterations are understood within the context of this description to mean in particular alterations that were caused by a user. The user can naturally use a computer in this case. By way of example, the user can be an expert in the development of motor vehicles, in particular an engineer.

In this embodiment, the reward function learns which user alterations have a positive or negative influence on the behavior of the model during accidents. In particular, the reward function can learn what goal or goals the user is pursuing from the user alterations. As such, for example specific components may be particularly important for the stability of the model during accidents, while other components are less important therefor. The self-learning reward function can thus rate the modifications as positive or negative in view of the goals pursued by the user.

The use of the reward function is particularly advantageous if the method is performed as machine learning using an agent that is rewarded for positive ratings of the modifications.

According to one embodiment of the invention, the learning can result in a behavior of the user who makes the user alterations being generalized. This is understood within the context of this description to mean in particular that a general approach is interpolated from the behavior of the user when a finite number of user alterations are made, which means that far more than the finite number of user alterations made can be used for the learning of the reward function on the basis of this general approach.

Moreover, the learning can result in the user alterations collectively being rated as more positive than other alterations to the computer-generated model. By way of example, the other alterations can be understood to mean hypothetical alterations that were not made by the user, however. The different rating of alterations means that the reward function can in particular learn which modifications are supposed to be rated as positive or negative in order to achieve the best possible improvement in the behavior of the model during the simulated accidents. For this purpose, it is in particular possible for the reward function to be adapted during the learning in such a way that the user alterations are rated as positively as possible. The result of this is that even modifications that are regarded as suitable for achieving the user's goal are rated as positively as possible.

According to one embodiment of the invention, the reward function can be a linear combination of various features. The features may be differently weighted. The weighting can be adapted during the learning. The features can comprise costs and/or safety coefficients, for example, the safety coefficients being numerical values that are dependent on the behavior of the component or of the model during accidents.

By way of example, the reward function R can be defined according to the following formula:

R=w₂·f₁+w₂·f₂+ . . . +wₙ·fₙ

Here, each wᵢ represents a weighting factor that can be altered during the learning. Each fᵢ represents a feature.

According to one embodiment of the invention, the respective deformations of the components during the respective simulated accident can be calculated from distances between picture elements of the components in the undeformed state and corresponding picture elements of the components in the deformed state. An undeformed state is understood to mean the state before the respective simulated accident. The corresponding picture elements can be the picture elements that have resulted from displacements from the picture elements in the undeformed state. The calculated deformations can then be added in order to calculate the respective deformation sum.

According to one embodiment of the invention, information about the modification and about the rating of the modification can be stored in a central data memory. The central data memory can be arranged remotely from the computer carrying out the computer-implemented method, for example. The central data memory can be a cloud data memory, for example. The deformation sums and the information can be used for modifying a further computer-generated model. The further computer-generated model can differ from the computer-generated model in one or more components.

As such, the rated modifications can also be taken into consideration for modifying the further model, with the result that modifications that can be given a better rating can sometimes be found more quickly than if the already rated modifications are not taken into consideration.

According to one embodiment of the invention, data from the data memory that were obtained for modifications to other computer-generated models can be used for the modification. The other computer-generated models can differ from the computer-generated model in one or more components. As such, better modifications can sometimes be found more quickly.

### BRIEF DESCRIPTION OF THE DRAWING FIGURES

Further features and advantages of the present invention will become clear from the description of preferred exemplary embodiments that follows with reference to the accompanying illustration, in which the same reference signs are used for identical or similar features and for features having identical or similar functions and in which

FIG. 1 shows a schematic sectional view of a detail from a computer-generated model of a motor vehicle;

FIG. 2 shows a schematic sectional view of the detail from FIG. 1 after a simulated accident;

FIG. 3 shows a schematic diagram of part of a method according to an embodiment of the invention;

FIG. 4 shows a schematic representation of an iteratively performed method according to an embodiment of the invention;

FIG. 5 shows a schematic representation of the method from FIG. 3 with a central data memory;

FIG. 6 shows a schematic representation of a method for improving a model with multiple agents;

FIG. 7 shows a schematic representation of a method for improving the reward function; and

FIG. 8 shows a schematic graph to illustrate a generalization of a strategy of a user.

### DETAILED DESCRIPTION OF THE INVENTION

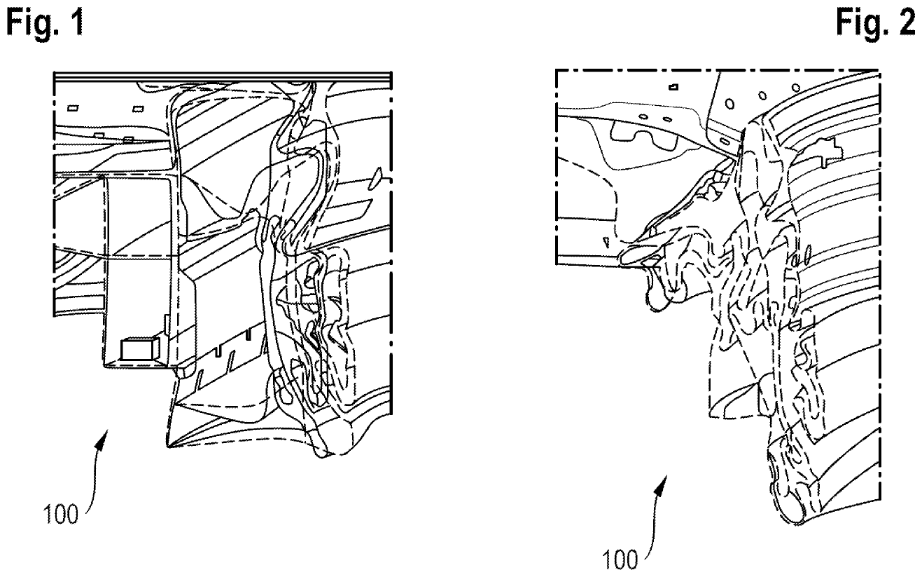

The model 100 shown in FIG. 1 comprises multiple components that correspond to real parts of a motor vehicle. Following the simulation of an accident, the components are deformed. This state is shown in FIG. 2. A video is produced from the simulation. By way of example, FIG. 1 can show a detail from a frame of this video before the accident. By way of example, FIG. 2 can show a detail from a frame of this video after the accident.

A comparison of the detail from FIG. 1 with the detail from FIG. 2 allows deformations of the components to be determined. These can be indicated by displacements of picture elements, for example. An extent of the deformations can thus be calculated by measuring the displacements of the picture elements. This can be effected in millimeters, for example. The individual displacements can be added to produce a deformation sum. The greater the deformation sum, the more greatly the components are deformed.

It is thus possible for two deformation sums to be compared with one another, for example. If for example one or more components of the model are modified and a second accident is subsequently simulated, the deformation sums of the model without and with modification can be compared with one another. The modification can then be rated positively if the deformation sum of the model with the modification is less than the deformation sum of the model without the modification.

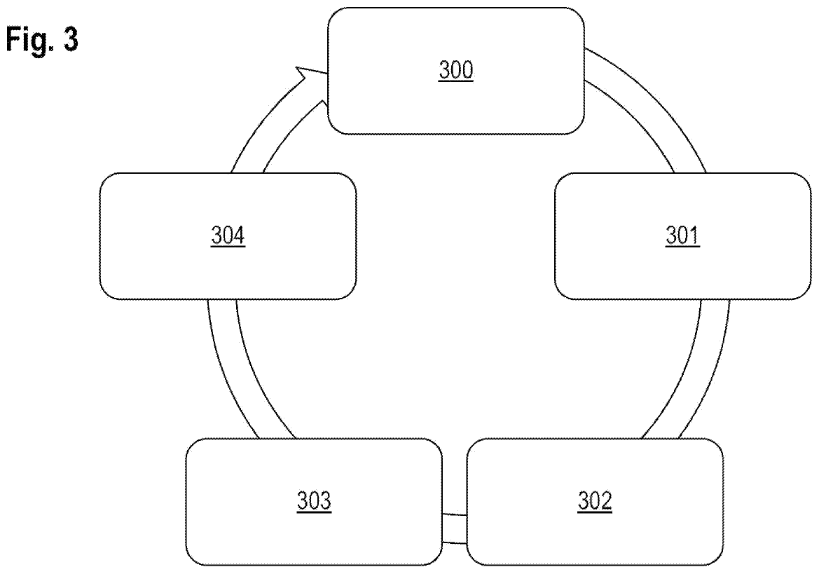

FIG. 3 shows an agent 300, a modification 301, a simulation 302, a calculation 303 of a deformation sum and a rating 304. It shows the operation of a method based on reinforcement learning. In one embodiment of the invention, the agent 300 selects a modification 301 of a component of the computer-generated model 100. The modification 301 can also be referred to as an action of the agent 300. The agent 300 follows a strategy as it does so. The modification 301 influences the simulation 302. The simulation 302 can also be referred to as an environment that is influenced by the action of the agent 300.

The calculation 303 results in the deformations of the components being calculated. The deformations are calculated by comparing the frame before the accident with the frame after the accident. These deformations are summed to produce the deformation sum.

The rating 304 of the modification 301 is effected on the basis of the deformation sum. The greater the sum, the poorer the rating. In particular, the rating 304 of the modification 301 can be effected such that the calculated deformation sum is compared with a deformation sum calculated before the modification 301. If the deformation sum calculated after the modification 301 is greater than the deformation sum calculated before said modification, the modification 301 is rated negatively. If it is less, the modification 301 is rated positively. The rating 304 can also be referred to as a reward for the agent 300.

The strategy of the agent 300 is matched to the rating 304. If the modification 301 is rated negatively, for example, this influences the strategy of the agent 300, with the result that remodification in a similar manner becomes less likely. Moreover, the modification 301 is rejected, since the model 100 without the modification 301 had better accident characteristics. The model 100 without the modification 301 is then taken as a basis for further modification.

If the modification 301 is rated positively, the model with the modification 301 is chosen as a basis for remodification, since the modification has improved the accident behavior of the model. This positive rating also influences the strategy of the agent 300, with the result that remodification in a similar manner becomes more likely.

The agent 300 is programmed to obtain as many positive ratings as possible. The more ratings the agent 300 obtains for different modifications, the better its strategy adapts in order to select the best possible modifications that have a positive influence on the accident behavior of the model 100.

The rating 304 can be effected in particular using a reward function. The reward function can include weighted features. By way of example, the features can include costs for producing a motor vehicle according to the modified model and a disparity between a target deformation sum and the calculated deformation sum. The target deformation sum can be a desirably low deformation sum, for example. The weighting can stipulate how the actions of the agent 300 are supposed to be rated. If for example the costs are weighted particularly highly, modifications leading to heightened costs tend to be more likely to be rated negatively if they have only a small positive influence on the deformation sum. If the disparity between the target deformation sum and the calculated deformation sum is weighted particularly highly, however, modifications that, despite leading to heightened costs, have a significant positive influence on the accident behavior are more likely to be rated positively. Since the agent 300 matches its strategy to the ratings, the strategy of the agent 300 is thus also influenced indirectly.

The method can be terminated if the calculation 303 results in a deformation sum that is below a threshold value being calculated. The threshold value can be a value specified in millimeters, for example.

The method shown in FIG. 3 is therefore an iterative method that is performed recurrently until it is terminated because the deformation sum is regarded as low enough. To achieve this goal, dynamic programming, strategy iteration methods and/or value iteration methods can be used during the planning of the method. Model-free control can involve Monte Carlo algorithms, temporal difference learning, Sarsa, Q learning and/or double-Q learning being used. It is also possible to carry out the method in model-based fashion by using one of the following types of algorithm: Dyna-Q, Monte Carlo tree search, temporal difference search. Moreover, model-based methods of reinforcement learning can be used, e.g. table lookup models, linear expectation models, linear gaussian models, gaussian process models and/or deep belief network models.

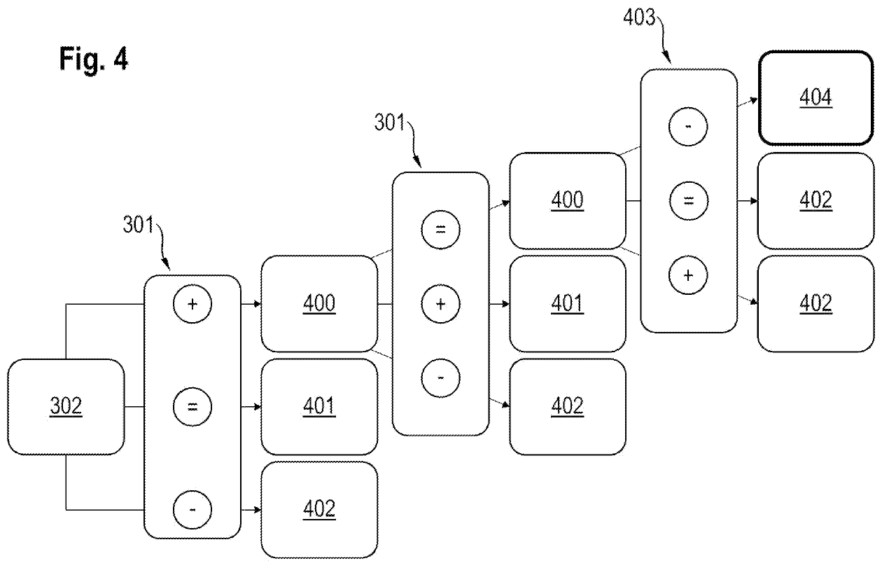

The method in FIG. 4 first involves an accident of a computer-generated model being simulated and a first deformation sum being calculated. First modifications 301 to one or more of the components of the model are then made. By way of example, a specific parameter is increased, decreased or left unchanged. A second deformation sum is then calculated, and compared with the first deformation sum, for each of all three first modifications 301. In step 400, one of the first modifications 301 is rated as positive because the second deformation sum thereof is lower than the first deformation sum. In step 401, one of the first modifications 301 is rated neutrally because the second deformation sum thereof is similar or equal to the first deformation sum. In step 402, one of the first modifications 301 is rated negatively because the second deformation sum thereof is greater than the first deformation sum. The positively rated modification 301 is used as a basis for second modifications 301. The positively rated modification 301 is thus treated as part of the model to which the second modifications 301 are made.

The results of the second modifications 301 are rated similarly to the results of the first modifications 301. Following third modifications 403, one of the third modifications 403 is rated positively in step 404. Moreover, with this third modification 403, the deformation sum meets the condition that it differs from a target deformation sum by less than a threshold value, for example 5%. This leads to the method being successfully terminated and the model with the third modification 403, which was rated positively in step 404, being regarded as a model with an accident behavior that is improved in accordance with the goal of the method. By way of example, this model can then be taken as a basis for manufacturing a motor vehicle.

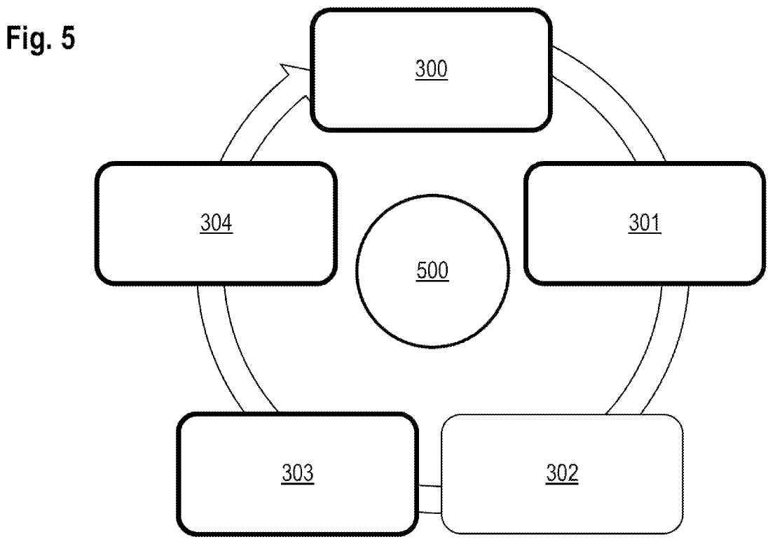

The method shown in FIG. 5 is based approximately on the method from FIG. 3. The central data memory 500 is added, however, which the agent 300 uses to store information about the modifications 301 made, the ratings 304 obtained and its strategy. This information can then be used by other agents for performing a similar method for other computer-generated models, with the result that better results are sometimes achieved there more quickly.

Moreover, the other agents can also store information about the modifications made, the ratings obtained and the strategies of said other agents, with the result that the agent 300 can access this information and can better adapt its modifications and/or its strategy.

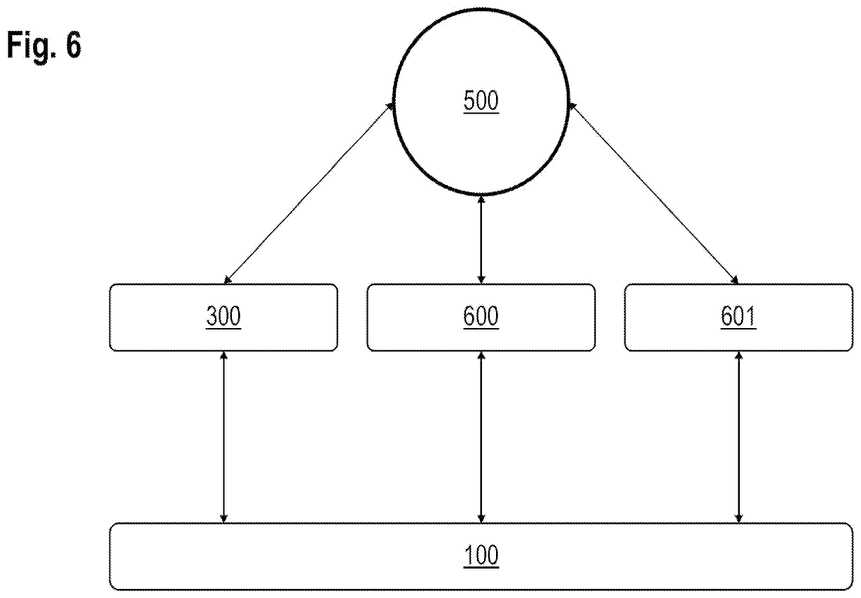

FIG. 6 shows multiple agents 300, 600 and 601, all of which—as described with reference to FIG. 5—store information in the central data memory 500 and retrieve information of the other agents from the central data memory 500. The agents 300, 600 and 601 all modify the same computer-generated model 100. This leads to the agents 300, 600 and 601 sometimes choosing different modifications and strategies. On the basis of the information exchanged via the central data memory 500, the agents 300, 600 and 601 can each benefit from the information of the other agents and improve their modifications and strategy in order to obtain more positive ratings. In particular, this approach allows any weaknesses that the individual agents 300, 600 and 601 may have to be compensated for at least in part.

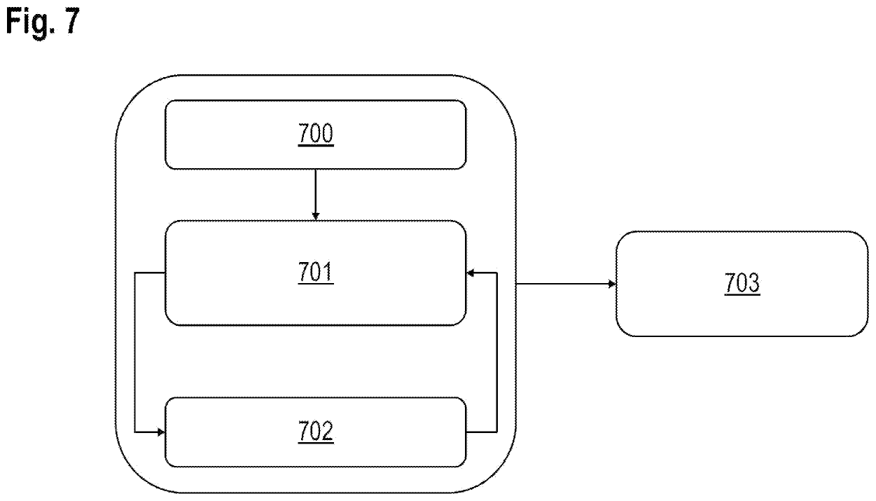

The method shown in FIG. 7 improves the reward function 702 that is used for rating 304 the deformation sums. The reward function 702 observes the behavior of a user 700 that makes modifications 701, the deformation sums of which—as described with reference to FIGS. 3 and 4 above—are rated. The reward function 702 comprises features and weightings of the features. The weightings of the features are adapted in order to obtain as many positive ratings as possible for the strategy of the user 700. The result of this adaptation is an improved reward function 703.

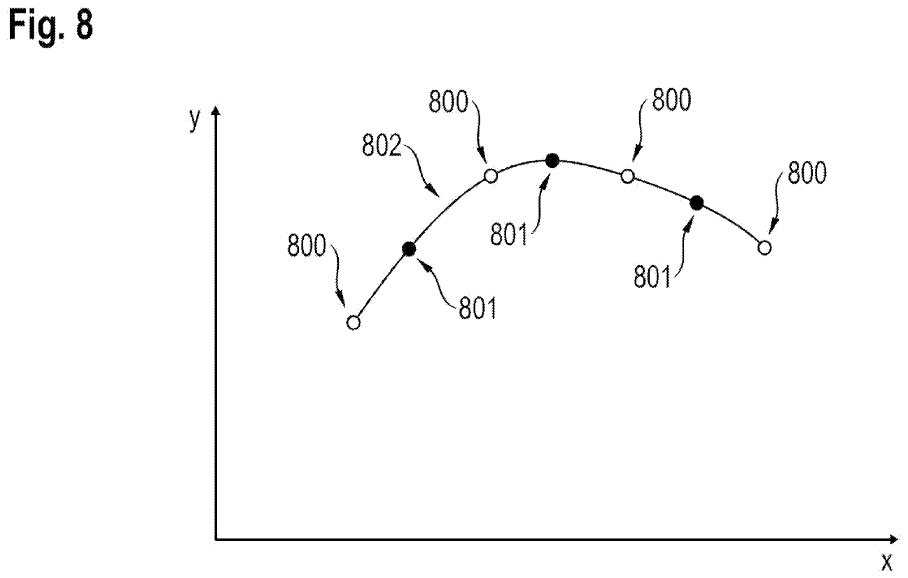

FIG. 8 shows how the behavior of the user 700 can be generalized. The user makes modifications that lead to the models 800 with different deformation sums. The Y-axis is a measure of the deformation sums. The smaller the deformation sum, the higher the model 800 is marked on the Y-axis.

The models 800 are used to produce generalized models 801 that could likewise be achieved by following the strategy of the user 700. Since the user 700 cannot make an infinite number of modifications, however, these are merely hypothetical models 801 for the user 700, which he has never produced in reality.

The models 800 and 801 are then used to produce a generalized curve 802 for the models, on which all or at least a majority of the models corresponding to the strategy of the user 700 lie. The reward function 702 can then be adapted such that these models are rated as positively as possible.

The computer-implemented method can naturally also, given appropriate adaptations for the parameters, perform simulations and automated analyses for calculations for a vehicle cooling system and effects of aerodynamic components of a vehicle on the aerodynamic characteristics.

What is claimed:

1. A computer-implemented method for modifying a component of a computer-generated model of a motor vehicle, wherein the method comprises:
(a) performing a first computer-generated simulation of a first simulated accident of the computer-generated model, wherein the computer-generated model comprises multiple components, the first computer-generated simulation resulting in at least some of the components of the model being deformed;
(b) producing a first video from the first computer-generated simulation, the first video visually representing the first simulated accident of the model;
(c) comparing frames of the first video with one another;
(d) calculating a first deformation sum from the comparison of the frames of the first video, the first deformation sum being calculated from deformations of the components during the first simulated accident;
(e) modifying at least one of the components;
(f) performing a second computer-generated simulation of a second simulated accident of the model with the at least one modified component, the second computer-generated simulation resulting in components of the model being deformed;
(g) producing a second video from the second computer-generated simulation, the second video visually representing the second simulated accident of the model;
(h) comparing frames of the second video with one another;
(i) calculating a second deformation sum from the comparison of the frames of the second video, the second deformation sum being calculated from deformations of the components during the second simulated accident;
(j) comparing the first deformation sum with the second deformation sum; and
(k) rating the modification at step (e) as either positive or negative on the basis of the comparison at step (j) of the first deformation sum with the second deformation sum.

2. The method as claimed in claim 1,
wherein the model with the at least one modified component is remodified if the modification was rated as positive, and the model with the at least one modified component is rejected if the modification was rated as negative,
wherein the remodification is followed by a third computer-generated simulation of a third simulated accident of the remodified model being performed and a third video being produced from the third computer-generated simulation,
the third computer-generated simulation resulting in components of the model being deformed, the third video visually representing the third simulated accident of the remodified model, wherein frames of the third video are compared with one another,
wherein a third deformation sum is calculated from the comparison of the frames of the third video, the third deformation sum being calculated from deformations of the components during the third simulated accident, and
wherein the remodification is rated as positive or negative on the basis of a comparison of the second deformation sum with the third deformation sum.

3. The method as claimed in claim 1, wherein the steps are repeated until a difference between a target deformation sum and one of the deformation sums is below a threshold value.

4. The method as claimed in claim 1, wherein the modified model is rated as positive if the second deformation sum is less than the first deformation sum.

5. The method as claimed in claim 1, wherein the modification is rated as positive or negative by a reward function, the reward function being of self-learning form, and, before rating the modification, the reward function learning from user alterations to the computer-generated model and the performance of simulations of accidents using the user-altered models.

6. The method as claimed in claim 5, wherein the learning results in a behavior of a user who makes the user alterations being generalized, and in that the learning results in the user alterations collectively being rated as more positive than other alterations to the computer-generated model.

7. The method as claimed in claim 5, wherein the reward function is a linear combination of features being differently weighted, and the weighting being adapted during the learning.

8. The method as claimed in claim 1, wherein the respective deformations of the components during the respective simulated accident are calculated from distances between picture elements of the components in an undeformed state and corresponding picture elements of the components in a deformed state.

9. The method as claimed in claim 1, further comprising:
storing in a central data memory the deformation sums, information about the modification and information about the rating of the modification, and
using the deformation sums and the information for modifying a further computer-generated model.

10. The method as claimed in claim 9, further comprising using for the modification data from the data memory that were obtained for modifications to other computer-generated models.
